(19) United States
(12) Patent Application Publication
(10) Pub. No.: US 2012/0274030 A1
(43) Pub. Date: Nov. 1, 2012

(54) Remotely Actuated Packing Follower

(76) Inventor: Franklin Dean Crnkovich, Wilder, ID (US)

(21) Appl. No.: 13/097,029

(22) Filed: Apr. 28, 2011

(51) Int. Cl. F16J 15/16

(52) U.S. Cl. 277/520

(57) ABSTRACT

A remotely actuated packing follower for compacting the packing in a base and base extension situated around a rotatable or longitudinally pulsatable shaft exiting a structure. The remotely actuated packing follower comprises a piston slidably and sealingly mounted within a housing and a packing follower cap sealingly attached to the top of the housing. The packing follower cap has a channel for fluid from a remote source to flow from a hose attached to the channel. The piston, housing, and packing follower cap create a chamber. When sufficient fluid flows into the chamber, it pushes the piston away from the packing follower cap so that the bottom of the piston can push against the packing. An inner channel in the piston accommodates the shaft. Either the remotely actuated packing follower or a traditional anti-leak fitting is optional constructed of releasably connectable sections.

### BACKGROUND OF THE INVENTION

1. Field of the Invention

This invention relates to a device for maintaining packing closely adjacent to a rotatable or longitudinally pulsatable shaft where such shaft extends from a structure, including—but not necessarily limited to—a machine in order to minimize the leakage of fluid through the aperture which permits the shaft to extend from the machine or other housing.

2. Description of the Related Art

The Inventor is aware of three patents for devices which utilize a fluid to place pressure on a seal.

The device of U.S. Pat. No. 5,333,882 deals with a seal around a pump shaft whereas the devices of U.S. Pat. Nos. 5,772,216 and 6,023,826 involve seals around a valve stem.

U.S. Pat. No. 5,333,882 employs both a fluid and springs to force carbon and silicon carbide seals together.

Lines 39 and 40 in column 5 provide, “A rotary seal member 42 is mounted on the inboard end of sleeve 20.” Lines 67 and 68 of column further explain, “A stationary seal member 54 is provided axially outwardly of rotary seal member 42.” Lines 4 through 7 in column 6 continue, “A narrow axially inwardly facing seal face 58 extends from the seal portion 56 toward and sealingly engages the seal face 46 of rotary seal member 42.” Lines 15 through 32 of column 6 then provide, “ . . . the stationary seal 54 is made of carbon and the rotary seal member 42 is made of silicon carbide.

“A second stationary seal member 54′ is provided outwardly of the first stationary seal member 54 in reverse orientation, i.e., with the seal face 58′ facing axially outwardly. Stationary seal member 54′ is identical to stationary seal member 54, and the corresponding portions thereof are designated with the same reference numerals differentiated by a prime designation. The ends of the stationary seal members 54, 54′ opposite seal faces 58, 58′ contact each other with notches 64, 64′ aligned.

“Similarly, outwardly of the second stationary seal member 54′ a second rotary seal member 42′, identical to rotary seal member 42 and reversely oriented relative thereto, is provided, with a seal face 46′ contacting the seal face 58′ of the second stationary seal member 54′ . . . .”

Next lines 5 through 11 in column 10 state, “In operation, sleeve 20 rotates with shaft 12 and carries with it rotary seal members 42, 42′ as well as lock ring 66 and springs 88. Stationary seal members 54, 54′ are held in a non-rotatably stationary position by lug 106 engaging notches 64, 64′ and gland 90. Springs 88 bias both pairs of seal faces 46, 58 and 46′, 58′ together and toward flange 26 at the other end of sleeve 20.” Lines 18 through 20 in column 10 declare, “Process fluid exerts a closing pressure force on seal faces 46, 58 as it exerts pressure on piston area B.” Lines 24 through 27 in column 10 continue, “Passing through notches 64, 64′ to the outer surface of sleeve 20, the barrier fluid exerts pressure on rear walls 52, 52′ of roatary seal members 42, 42′ at piston areas A and A′.” And lines 48 through 57 in column 10 state, “The springs 88 provide an initial bias toward the flange, and with process fluid exerting force on wall 62 of stationary seal 54, process fluid pressure further biases the assembly toward the flange. As barrier fluid pressure is applied at piston areas A and A′ inwardly from each end of the assembly with no net force in either direction, the spring force and any process fluid pressure at piston area B and the seal environment net pressure at B′, if any, always produces a net force toward the flange.”

U.S. Pat. No. 5,772,216 has six embodiments. They all employ a piston to pressurize fluid which directly exerts a force on sealing members 32 and 34. And for the first two embodiments spring stacks 66 are utilized with the fluid to create the pressure on the sealing members 32, 34, as explained in 1 through 6 of column 5: “In operation, sealant 80 is injected through sealant fitting 44 to fill sealant space 36 to a predetermined pressure. Bolts 52 are tightened against spring stacks 66 to place a predetermined load on sealing members 32, 34 and sealant 80 as spacer ring 68 and follower ring 38 move downwardly into chamber 30 against external sealing member 34.” Of course, such tightening requires an operator to be near the shaft 12.

And the Valve Packing Compression Apparatus of U.S. Pat. No. 6,023,826 employs an hydraulic pump to move a first end of a rocker arm. The second end of the rocker arm forces a gland follower into a stuffing box to compress packing rings. When the desired force is achieved, fasteners are “hand tightened”; and the hydraulic pump is deactivated.

A more detailed explanation is given in lines 26 through 43 of column 8: “With the hydraulic pressure output of hydraulic pump 60 set by the regulator 62 (ref. FIG. 1) at a predetermined value, on/off valve 66 is switched to the ‘on’ position. . . . Once valve 66 is switched to the ‘on’ position, piston 58 extends from hydraulic ram 54 urging rocker arm 70 to pivot about dowel pin 72. Tines 78 and 80 drive gland follower 28 vertically down into the stuffing box bore 18 of stuffing box 16 compressing packing rings 24 (ref. FIG. 1) a predetermined amount. When the loading force levels off and remains steady, fasteners 108 and 110 are hand tightened and thereafter on/off valve 66 is switched to the ‘off’ position, retracting hydraulic ram 54.

### BRIEF SUMMARY OF THE INVENTION

The present Remotely Actuated Packing Follower comprises a piston sealingly and slidably mounted within a housing. A ledge separates the upper portion of the piston from the lower portion of the piston; and the outer surface of the upper portion of the piston is inwardly offset from the outer surface of the lower portion of the piston to create a chamber surrounded by the top of the ledge, the outer surface of the upper portion of the piston, the inner surface of the housing, and the bottom of a packing follower cap sealingly attached to the top of the housing. The piston has an inner channel of such a cross-sectional shape and dimensions as slidably to accommodate a shaft extending from a structure

The packing follower cap possesses a channel proceeding from the top of said packing follower cap to the bottom of said packing follower cap and thereby establishing fluid communication from a beginning of the channel to the chamber. Preferably, a fitting, for connecting a hose, is attached to said packing follower cap at the beginning of the channel in fluid communication with channel so that fluid from a remote source may be introduced into the chamber to force the piston down so that the bottom of the piston compresses packing around the shaft.

No springs are utilized, and no operator needs to be near the shaft.

### BRIEF DESCRIPTION OF THE SEVERAL VIEWS OF THE DRAWING

FIG. 1 shows a first embodiment of a traditional traditional anti-leak fitting.

FIG. 2 portrays a second embodiment of a traditional traditional anti-leak fitting.

FIG. 3 is an exploded view of the Remotely Actuated Packing Follower.

FIG. 4 is a cross-sectional view of the Remotely Actuated Packing Follower.

FIG. 5 is an elevational view of a packing follower cap built with at least two releasably connectable packing follower cap longitudinal sections.

FIG. 6 is a plan view from above of a packing follower cap built with two releasably connectable packing follower cap longitudinal sections.

FIG. 7 is an elevational view of a piston built with two releasably connectable piston longitudinal sections.

FIG. 8 is a plan view from below a piston built with two releasably connectable piston longitudinal sections.

FIG. 9 is an elevational view of a housing.

FIG. 10 is a plan view from below a housing built with two releasably connectable housing longitudinal sections.

FIG. 11 is an exploded view of a splittable and recombinable Remotely Actuated Packing Follower.

FIG. 12 is an exploded view of a splittable and recombinable traditional anti-leak fitting.

### DETAILED DESCRIPTION OF THE INVENTION

When a rotating or longitudinally pulsating shaft exits a structure, it is often desirable to minimize or eliminate fluid from leaving the shaft (as in the case of a well drill) or fluid from entering the shaft (as in the case of the shaft connecting a marine engine and a propeller).

A device that has been traditionally used to accomplish this purpose is sometimes termed a “gland” and other times, a “stuffing box.” Still other references indicate the male portion of the device comprises a gland and a gland follower while the female portion of the device is designated as the stuffing box.

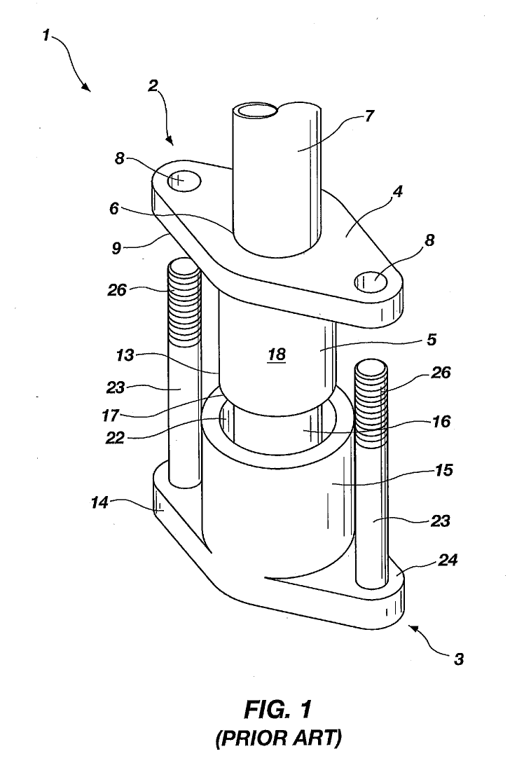

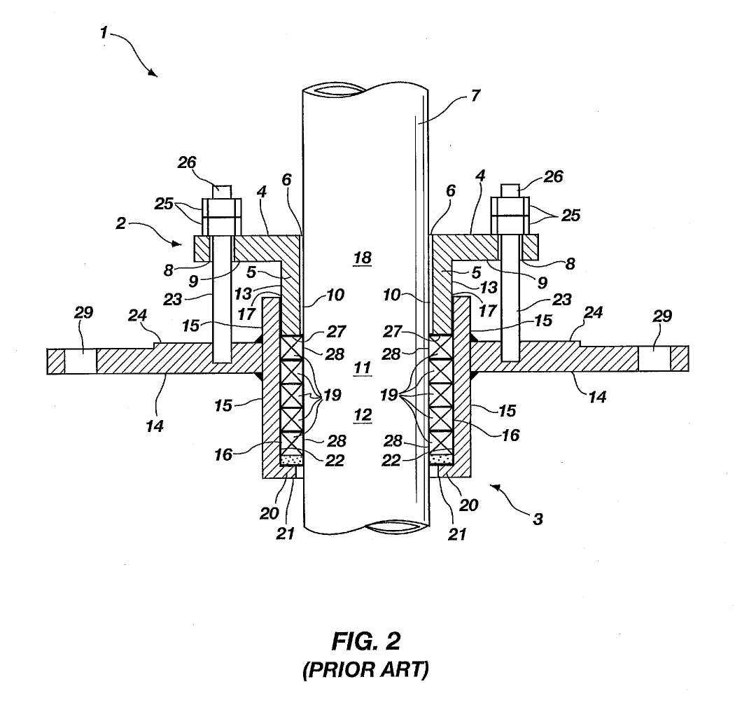

In any event, the traditional device is illustrated in FIG. 1 and FIG. 2. And, with the goal of eliminating confusion, logical terminology for the device and its components will be designated herein.

The device, itself, is termed an “anti-leak fitting” 1 and comprises two principal parts: a male portion 2 and a female portion 3, as seen in FIGS. 1 and 2.

The male portion 2, itself, comprises a cap 4 and a packing follower (sometimes also called a “gland follower”) 5. The cap 4 extends away from a central aperture 6 which has such a dimension as to accommodate the moving shaft 7 and may, for example, be in an elongate, circular, or oblong shape. At least two outer apertures 8 in the cap 4 are preferably located radially outward, preferably—when there are two apertures—in substantially opposite directions from the central aperture 6. Extending from a lower side 9 of the cap 4 and, preferably, concentrically aligned with the central aperture 6 is a lower extension (termed the “packing follower”) 5 having a hollow central portion 10 preferably with the same cross-sectional shape 11 as the cross-sectional shape 12 of the shaft 7 and having such dimensions as to permit the shaft 7 (or a sleeve (not illustrated) that is optionally placed around the shaft 7, in order to reduce wear, and moves with the shaft 7) to move within the hollow central portion 10 and also having an outer diameter 13.

The female portion 3 comprises a base 14 preferably having the same shape and dimensions as the cap 4; a base extension 15 proceeding upward and, optionally, also downward or only downward having a central aperture 16 preferably with the same shape as the shape of the outer portion 17 of the cross section 18 of the lower extension (packing follower) 5 and also having such dimension as to accommodate the lower extension (packing follower) 5; packing 19 within the central aperture 16 of the base extension 15 having such a shape and dimensions that it is adjacent to the shaft 7 (or to a sleeve (not illustrated) that is optionally placed around the shaft 7, in order to reduce wear, and moves with the shaft 7) when the base extension 15 has been installed around the shaft 7; a stop 20, which is usually a flange 21 extending inwardly from an inner wall 22 of the base extension 15 (but which can optionally be a flange extending outward from the sleeve if the shaft 7 moves only rotationally) in order to limit the motion of the packing 19; at least two studs 23 projecting from the upper surface 24 of the base 14 and so located as to be aligned with two of the outer apertures 8, in the cap 4; nuts 25 for placement on the free ends 26 of the studs 23, after such free ends 26 have passed through the outer apertures 8 for securing the cap 4 to the base 14 and urging the cap 4, and thereby the lower extension (packing follower) 5 toward the base 14, which urging causes a force to be exerted by the bottom 27 of the lower extension (packing follower) 5 on the packing 19 and, because of the stop 20, also causes the packing 19 to have its inner surface 28 move farther inward (in order to compensate for wear of the packing 19 caused by the movement of the shaft 7 (or sleeve, when a sleeve is employed) against the packing 19 and to improve the fluidic seal created by having the packing 19 adjacent to the shaft 7 (or sleeve, when a sleeve is employed)); and a means for attaching the base 14 to the structure (not illustrated) (often a casing, in the drilling industry) from which the shaft 7 exits. Often such means is two or more apertures (or channels) 29 for accommodating bolts to which nuts are fastened, bolts that screw into the structure, or studs projecting from the structure which are similar to the studs 23 extending from the upper surface 24 of the base 14.

Frequently, because of operational constraints, the nuts 25 have to be tightened while the shaft 7 is moving, creating a substantial danger for the person who is required to do the tightening. And sometimes, as with the propeller shaft for a boat, the anti-leak fitting 1 and, consequently, the nuts 25 are within another housing (not illustrated).

The present invention, i.e., the Remotely Actuated Packing Follower, eliminates the need for the individual doing the tightening to be near a moving shaft 7 and also, when the anti-leak fitting 1 is within another housing (not illustrated), the need to gain access to the nuts 25 through a housing by remotely actuating the lower extension (packing follower) 5.

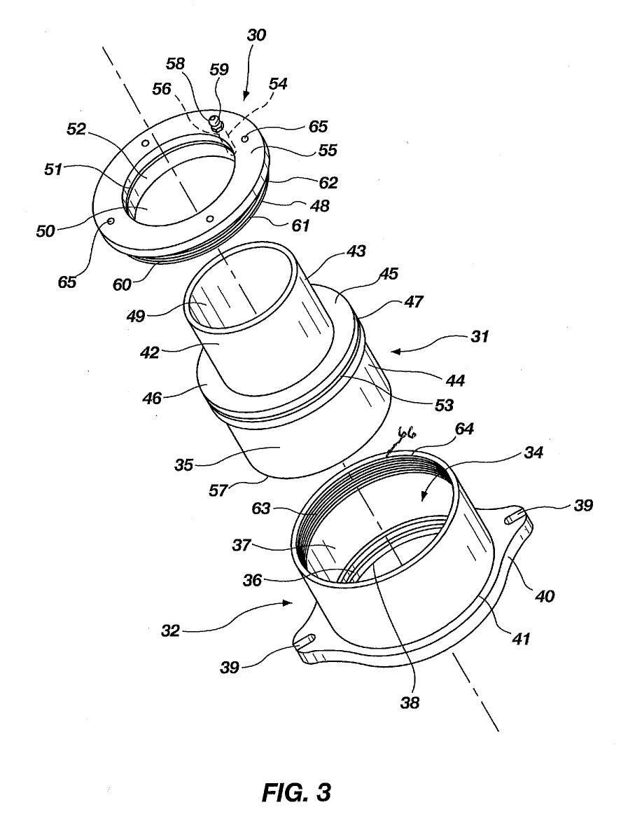

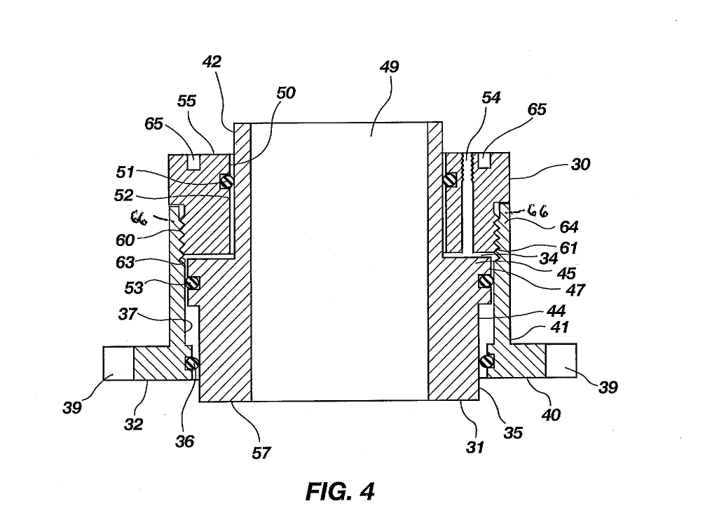

The Remotely Actuated Packing Follower replaces the elements of the male portion 2 of the anti-leak fitting with a cap 30 designated the “packing follower cap,” a piston 31, and a housing 32, as depicted in FIGS. 3 and 4.

The housing 32 has an inner channel 34 of such a cross-sectional shape (preferably, circular) and dimensions as sealingly and slidably to accommodate the lower portion 35 of the piston 31. Preferably, an O-ring 36, designated the “housing O-ring,” is located in the inner surface 37 of the housing 32 near the lower end 38 of the inner channel 34. And the housing 32 also possesses a means for attaching the housing 32 to the female portion 3. Preferably, such means is two or more apertures (or channels) 39, for accommodating the studs 23 extending from the upper surface 24 of the base 14, and nuts 25; such apertures (or channels) 39 are located in a flange 40 extending outwardly from the housing 32, preferably near the bottom 41 of the housing 32; and such apertures (or channels) 39, when there are two such apertures (or channels) 39 are also preferably in substantially opposite directions from the inner channel 34.

The outer surface 42 of the upper portion 43 of the piston 31 is inwardly offset from the outer surface 44 of the lower portion 35 of the piston 31 and connected to the lower portion 35 of the piston 31 with a ledge 45 in order to create a chamber 46 surrounded by the top 47 of the ledge 45, the inner surface 37 of the housing 32, the outer surface 42 of the upper portion 43 of the piston 31, and the bottom 48 of the packing follower cap 30. Both the upper portion 43 and the lower portion 35 of the piston 31 preferably have a cylindrical cross section. The piston 31 possesses an inner channel 49 of such a cross-sectional shape (preferably, circular) and dimensions as slidably to accommodate the shaft 7.

The packing follower cap 30 has an inner channel 50 of such a cross-sectional shape (preferably, circular) and dimensions as sealingly to accommodate the upper portion 43 of the piston 31. Preferably, an O-ring 51, designated the “packing follower cap O-ring,” is located in the inner surface 52 of the inner channel 50 of the packing follower cap 30; and, also preferably, an O-ring 53, designated the “piston O-ring,” is located on the outer surface 44 of the lower portion 35 of the piston 31. A channel 54 proceeds from the top 55 of the packing follower cap 30 to the bottom 48 of the packing follower cap 30, thereby establishing fluid communication from the beginning 56 of the channel 54 to the chamber 46.

A fluid (not illustrated), preferably grease, can then be introduced through the beginning 56 of the channel 54 and forced through the channel 54 into the chamber 46. The pressure exerted by this fluid, consequently, urges the ledge 45 and, therefore, the entire piston 31 toward the packing 19. The bottom 57 of the piston 31 then acts on the packing 19 just as does the bottom 27 of the lower extension (packing follower) 6 in the traditional “anti-leak fitting” and produces the same desired inward movement of the inner surface 28 of the packing 19.

Preferably, a fitting 58 for connecting a hose (not illustrated) is attached in fluid communication to the packing follower cap 30 at the beginning 56 of the channel 54; and a check valve 59 is inserted into either the fitting 58 or the channel 54 in order to prevent the fluid from escaping backward, i.e., from the chamber 46 to the channel 54) through the channel. And, even more preferably, the check valve 59 and fitting 58 are in the form of a unitary zerk. Because of the check valve 59, fluid need not be supplied continually.

Also, a means exists for sealingly and removably securing the packing follower cap 30 to the housing 32. This preferably comprises threads 60 on the outer lateral surface 61 of the lower portion 62 of the packing follower cap 30 and mating threads 63 on the upper portion 64 of the inner surface 37 of the housing 32. Also preferably, two or more cavities 65 are present in the top 55 of the packing follower cap 30 in order both (a) to facilitate tightening of the follower cap 30 threads 60 to the mating threads 63 and (b) to assist with the machining needed to create the threads 60. Optionally, however, the packing follower cap 30 can be permanently attached to the top 66 of the housing 32 to enclose such top 66, preferably as an integral part of such housing 32.

Thus, the tightening of the packing 19 against the shaft 7 (or sleeve, when a sleeve is employed) and the resultant improvement of the fluidic seal created by having the packing 19 adjacent to the shaft 7 (or sleeve, when a sleeve is employed) can be accomplished remotely and not require an individual to be near the moving shaft 7.

Optionally, in order to obviate the need for disassembling the structure having a rotating or longitudinally pulsating shaft exiting such structure when either a traditional anti-leak fitting or the Remotely Actuated Packing Follower of the present application is to be removed temporarily form attachment to such structure the traditional anti-leak fitting or the Remotely Actuated Packing Follower, depending on which has been attached to the structure, is splittable and recombinable.

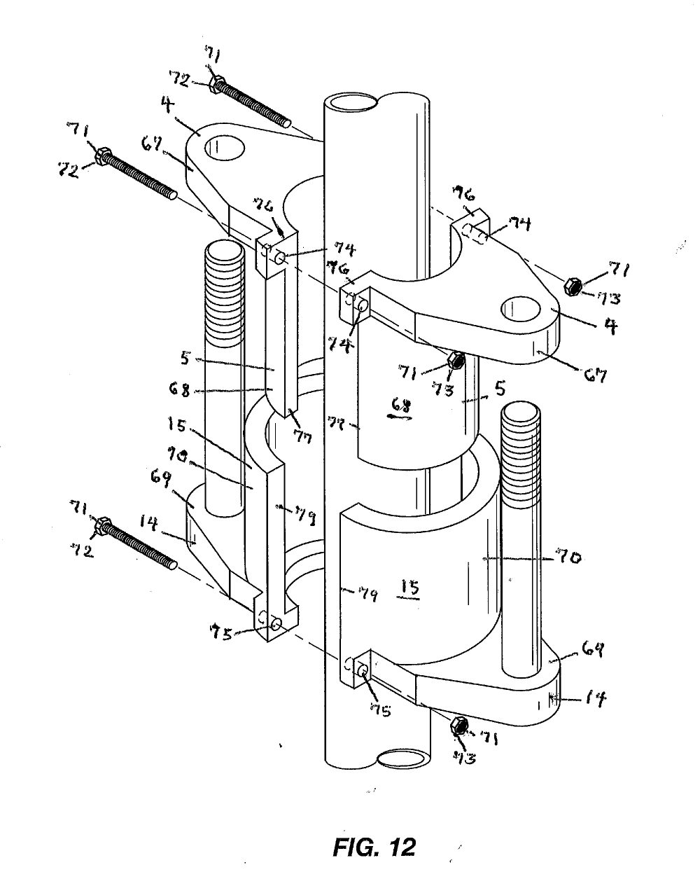

For the traditional anti-leak fitting the cap 4 is built, as illustrated in FIG. 12, with at least two releasably connectable longitudinal sections 67, designated the “cap longitudinal sections,” with no section 67 being so large that such section 67 can not be removed from around the shaft 7 after the sections 67 have been separated from one another, and the packing follower 5 is similarly is built with at least two releasably connectable longitudinal sections 68, designated the “packing follower longitudinal sections,” with no section 68 being so large that such section 68 can not be removed from around the shaft 7 after the sections 68 have been separated from one another. As a further option, if it is desired to remove the base 14 and the base extension 15, the base 14 is built with at least two releasably connectable longitudinal sections 69, designated the “base longitudinal sections,” with no section 69 being so large that such section 69 can not be removed from around the shaft 7 after the sections 69 have been separated from one another, and the base extension 15 is similarly is built with at least two releasably connectable longitudinal sections 70, designated the “base extension longitudinal sections,” with no section 70 being so large that such section 70 can not be removed from around the shaft 7 after the sections 70 have been separated from one another.

Releasable connectors 71 are utilized releasably to connect the sections 67, 68, 69, 70. Preferably, bolts 72 and nuts 73 are used in conjunction with apertures 74 in the cap 4 and apertures 75 in the base 14.

Additionally, silicone gasket maker such as that manufactured by Permatex (a subsidiary of Illinois Tool Works, Inc.) of Hartford, Conn., is preferably placed between the edges 76 of the sections 67 of the cap 4 which mate with one another, the edges 77 of the sections 68 of the packing follower 5 which mate with one another, the edges 78 of the sections 69 of the base 14 which mate with one another, and the edges 79 of the sections 70 of the base extension 15 which mate with one another.

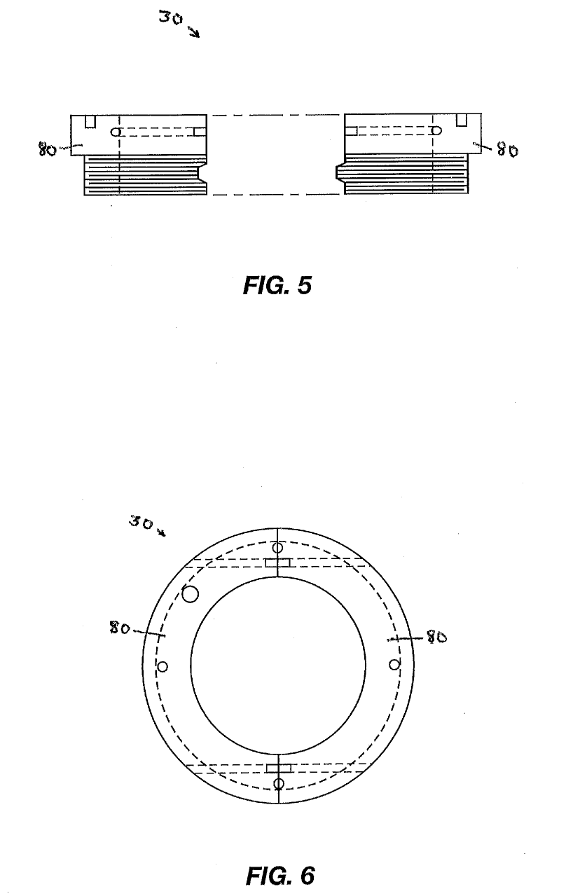

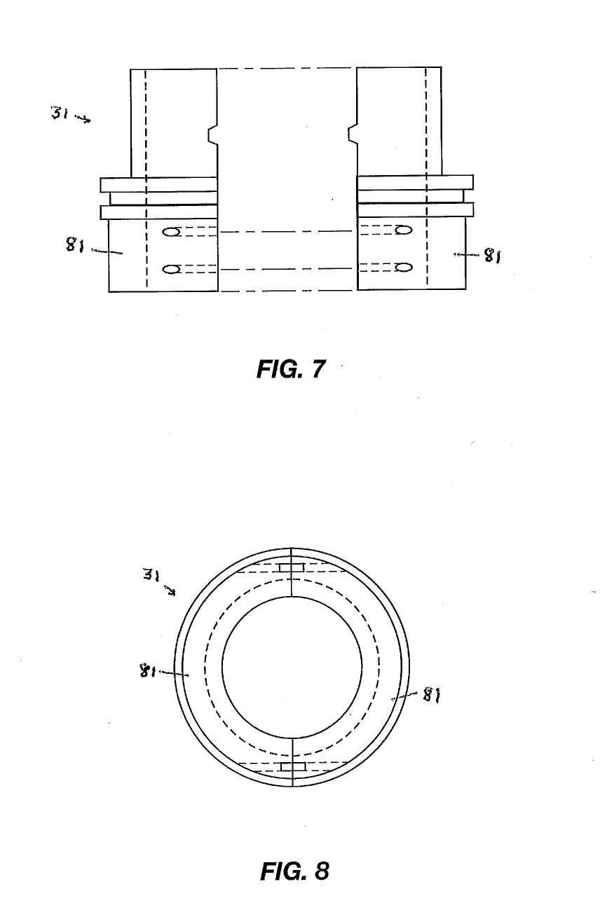

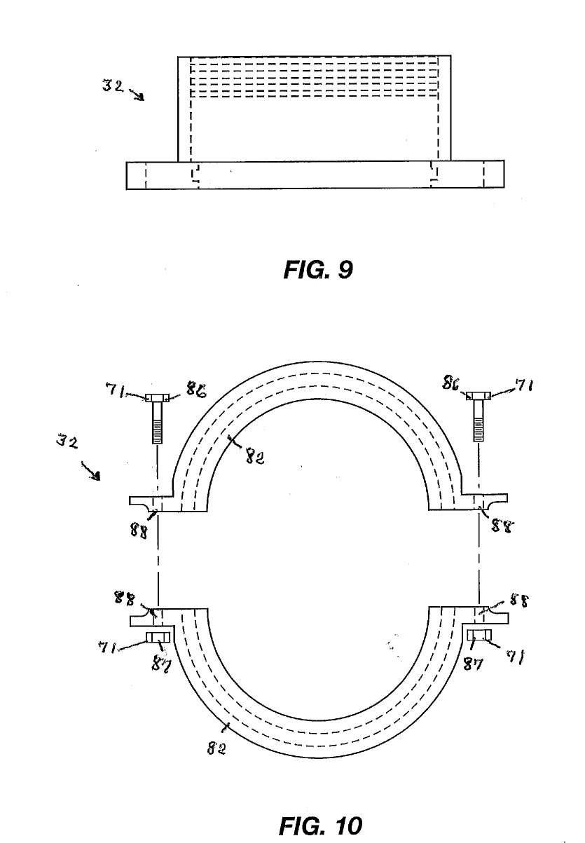

For the Remotely Actuated Packing Follower of the present application the cap 30 is built, as shown in FIGS. 5, 6, and 11, with at least two releasably connectable longitudinal sections 80, designated “packing follower cap longitudinal sections,” with no section 80 being so large that such section 80 can not be removed from around the shaft 7 after the sections 80 have been separated from one another, the piston 31 is built, as depicted in FIGS. 7, 8, and 11, with at least two releasably connectable longitudinal sections 81, designated “piston longitudinal sections,” with no section 81 being so large that such section 81 can not be removed from around the shaft 7 after the sections 81 have been separated from one another, and the housing 32 is built, as illustrated in FIGS. 9, 10, and 11, with at least two releasably connectable longitudinal sections 82, designated “housing longitudinal sections,” with no section 82 being so large that such section 82 can not be removed from around the shaft 7 after the sections 82 have been separated from one another. Again, as a further option, if it is desired to remove the base 14 and the base extension 15, the base 14 is built with at least two releasably connectable longitudinal sections 69 with no section 69 being so large that such section 69 can not be removed from around the shaft 7 after the sections 69 have been separated from one another, and the base extension is similarly is built with at least two releasably connectable longitudinal sections 70 with no section 70 being so large that such section 70 can not be removed from around the shaft 7 after the sections 70 have been separated from one another.

Releasable connectors 71 are utilized releasably to connect the sections 69, 70, 71, 80, 81, 82. Preferably, Allen screws 83 are employed in conjunction with threaded apertures 84 in the cap 30 and threaded apertures 85 in the piston 31 whereas bolts 86 and nuts 87 are used in conjunction with apertures 88 in the housing 32. And if the base 14 as well as the base extension 15 are removable, bolts 72 and nuts 73 are utilized in conjunction with apertures 74 in the base 14.

And once again, silicone gasket maker such as that manufactured by Permatex (a subsidiary of Illinois Tool Works, Inc.) of Hartford, Conn., is preferably placed between the edges 89 of the sections 80 of the cap 30 which mate with one another, the edges 90 of the sections 81 of the piston 31 which mate with one another, the edges 91 of the sections 82 of the housing 32 which mate with one another, the edges 78 of the sections 69 of the base 14 which mate with one another, and the edges 79 of the sections 70 the base extension 15 which mate with one another.

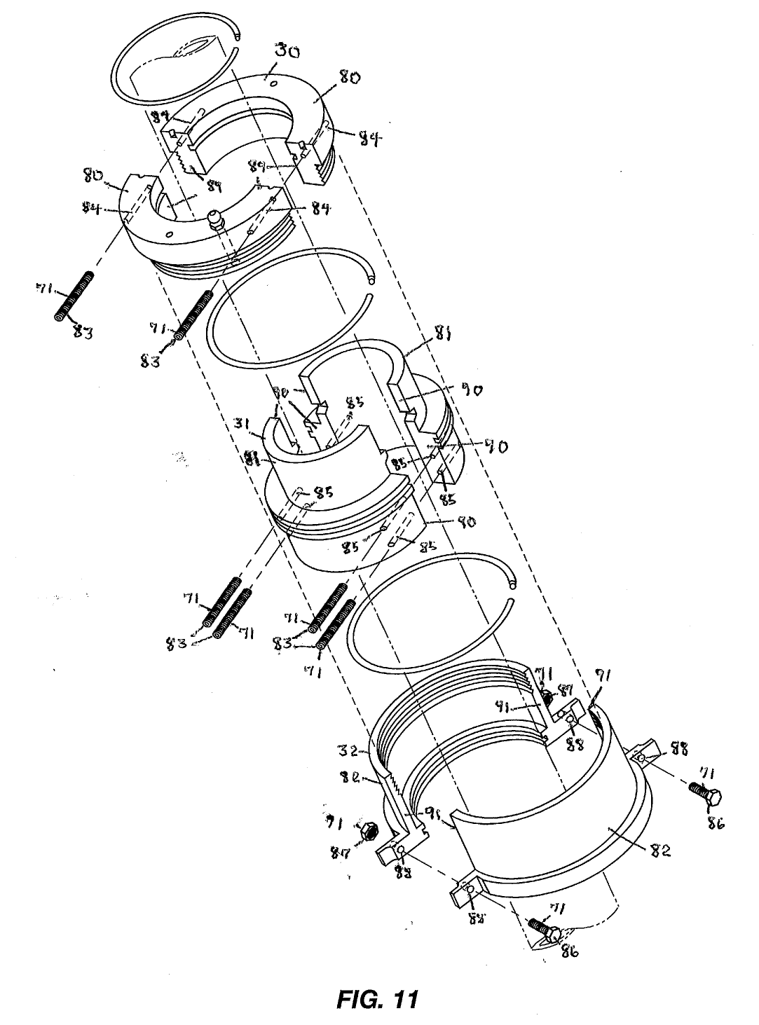

When O-rings 36, 51, and 53 are employed with the splittable and recombinable option for the Remotely Actuated Packing Follower, splittable and recombinable O-rings, such as those termed “ball-and-socket o-rings” that are manufactured by the A.W. Chesterton Company of Woburn, Mass., and which consumers are able to view on the Internet at http://www.chesterton.com/Product %20Documents/MSD/Product %20Brochures/sb442_EN.pdf. are utilized, as illustrated in FIG. 11.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A remotely actuated packing follower for a structure having a shaft extending from the structure, which comprises:
a piston with a lower portion having an outer surface, with an upper portion inwardly offset from the outer surface of the lower portion, with a ledge having a top and connecting the upper portion of the piston to the lower portion of the piston, with an inner channel of such a cross-sectional shape and dimensions as slidably to accommodate the shaft extending from the structure, with a lower end of the inner channel, and with a bottom;
a housing with a top, with an inner channel of such a cross-sectional shape and dimensions as sealingly and slidably to accommodate the lower portion of said piston, with an inner surface around the inner channel, with a lower end of the inner surface around the inner channel, and with a means for attaching said housing to a female portion of a traditional anti-leak fitting; and
a packing follower cap having an inner channel of such a cross-sectional shape and dimensions as sealingly to accommodate the upper portion of said piston with an inner surface around the inner channel, having a top, and having a bottom and thereby creating a chamber surrounded by the top of the ledge of said piston, the inner surface of said housing, the outer surface of the upper portion of said piston, and the bottom of said packing follower cap, said packing follower cap also having a channel proceeding from the top of said packing follower cap to the bottom of said packing follower cap and thereby establishing fluid communication from a beginning of the channel to the chamber, and said packing follower cap being permanently attached to the top of said housing to enclose the top of said housing.

2. The remotely actuated packing follower for a structure having a shaft extending from the structure as recited in claim 1, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from the structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another; and
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another.

3. The remotely actuated packing follower for a structure having a shaft extending from the structure as recited in claim 2, further comprising:
silicone gasket maker placed between the edges of the packing follower cap longitudinal sections which mate with one another, the edges of the piston longitudinal sections which mate with one another, and the edges of the housing longitudinal sections which mate with one another.

4. The remotely actuated packing follower for a structure having a shaft extending from the structure as recited in claim 1, further comprising:
a fitting, for connecting a hose, attached to said packing follower cap at the beginning of the channel in fluid communication with channel;
and a check valve inserted into either the combined fitting and channel in order to allow fluid to flow from the channel into the chamber but not flow from the chamber into the channel.

5. The remotely actuated packing follower for a structure having a shaft extending from the structure as recited in claim 4, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another; and
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another.

6. The remotely actuated packing follower for a structure having a shaft extending from the structure as recited in claim 5, further comprising:
silicone gasket maker placed between the edges of the packing follower cap longitudinal sections which mate with one another, the edges of the piston longitudinal sections which mate with one another, and the edges of the housing longitudinal sections which mate with one another.

7. The remotely actuated packing follower for a structure having a shaft extending from the structure as recited in claim 1, further comprising:
a packing follower cap O-ring located in the inner surface of the inner channel of said packing follower cap;
a piston O-ring located on the outer surface of the lower portion of said piston; and
a housing O-ring located in the inner surface of the housing near the lower end of the inner channel.

8. The remotely actuated packing follower for a structure having a shaft extending from the structure as recited in claim 7, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another;
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another; and
the packing follower cap O-ring is splittable and recombinable, the piston O-ring is splittable and recombinable, and the housing O-ring is splittable and recombinable.

9. The remotely actuated packing follower for a structure having a shaft extending from the structure as recited in claim 8, further comprising:
silicone gasket maker placed between the edges of the packing follower cap longitudinal sections which mate with one another, the edges of the piston longitudinal sections which mate with one another, and the edges of the housing longitudinal sections which mate with one another.

10. The remotely actuated packing follower for a structure having a shaft extending from the structure as recited in claim 7, further comprising:
a fitting, for connecting a hose, attached to said packing follower cap at the beginning of the channel in fluid communication with channel;
and a check valve inserted into either the combined fitting and channel in order to allow fluid to flow from the channel into the chamber but not flow from the chamber into the channel.

11. The remotely actuated packing follower for a structure having a shaft extending from the structure as recited in claim 10, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another;
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another; and
the packing follower cap O-ring is splittable and recombinable, the piston O-ring is splittable and recombinable, and the housing O-ring is splittable and recombinable.

12. The remotely actuated packing follower for a structure having a shaft extending from the structure as recited in claim 11, further comprising:
silicone gasket maker placed between the edges of the packing follower cap longitudinal sections which mate with one another, the edges of the piston longitudinal sections which mate with one another, and the edges of the housing longitudinal sections which mate with one another.

13. A remotely actuated packing follower for a structure having a shaft extending from the structure, which comprises:
a piston with a lower portion having an outer surface, with an upper portion inwardly offset from the outer surface of the lower portion, with a ledge having a top and connecting the upper portion of the piston to the lower portion of the piston, with an inner channel of such a cross-sectional shape and dimensions as slidably to accommodate the shaft extending from the structure, with a lower end of the inner channel, and with a bottom;
a housing with a top, with an inner channel of such a cross-sectional shape and dimensions as sealingly and slidably to accommodate the lower portion of said piston, with an inner surface around the inner channel, with a lower end of the inner surface around the inner channel, and with a means for attaching said housing to a female portion of a traditional anti-leak fitting; and
a packing follower cap having an inner channel of such a cross-sectional shape and dimensions as sealingly to accommodate the upper portion of said piston with an inner surface around the inner channel, having a top, and having a bottom and thereby creating a chamber surrounded by the top of the ledge of said piston, the inner surface of said housing, the outer surface of the upper portion of said piston, and the bottom of said packing follower cap, said packing follower cap also having a channel proceeding from the top of said packing follower cap to the bottom of said packing follower cap and thereby establishing fluid communication from a beginning of the channel to the chamber, and said packing follower cap being sealingly and removably attached to the top of said housing to enclose the top of said housing.

14. The remotely actuated packing follower for a structure having a shaft extending from the structure as recited in claim 13, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another; and
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another.

15. The remotely actuated packing follower for a structure having a shaft extending from the structure as recited in claim 14, further comprising:
silicone gasket maker placed between the edges of the packing follower cap longitudinal sections which mate with one another, the edges of the piston longitudinal sections which mate with one another, and the edges of the housing longitudinal sections which mate with one another.

16. The remotely actuated packing follower for a structure having a shaft extending from the structure as recited in claim 13, further comprising:
a fitting, for connecting a hose, attached to said packing follower cap at the beginning of the channel in fluid communication with channel;
and a check valve inserted into either the combined fitting and channel in order to allow fluid to flow from the channel into the chamber but not flow from the chamber into the channel.

17. The remotely actuated packing follower for a structure having a shaft extending from the structure as recited in claim 16, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another; and
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another.

18. The remotely actuated packing follower for a structure having a shaft extending from the structure as recited in claim 17, further comprising:
silicone gasket maker placed between the edges of the packing follower cap longitudinal sections which mate with one another, the edges of the piston longitudinal sections which mate with one another, and the edges of the housing longitudinal sections which mate with one another.

19. The remotely actuated packing follower for a structure having a shaft extending from the structure as recited in claim 13, further comprising:
a packing follower cap O-ring located in the inner surface of the inner channel of said packing follower cap;
a piston O-ring located on the outer surface of the lower portion of said piston; and
a housing O-ring located in the inner surface of the housing near the lower end of the inner channel.

20. The remotely actuated packing follower for a structure having a shaft extending from the structure as recited in claim 19, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another;
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another; and
the packing follower cap O-ring is splittable and recombinable, the piston O-ring is splittable and recombinable, and the housing O-ring is splittable and recombinable.

21. The remotely actuated packing follower for a structure having a shaft extending from the structure as recited in claim 20, further comprising:
silicone gasket maker placed between the edges of the packing follower cap longitudinal sections which mate with one another, the edges of the piston longitudinal sections which mate with one another, and the edges of the housing longitudinal sections which mate with one another.

22. The remotely actuated packing follower for a structure having a shaft extending from the structure as recited in claim 19, further comprising:
a fitting, for connecting a hose, attached to said packing follower cap at the beginning of the channel in fluid communication with channel;
and a check valve inserted into either the combined fitting and channel in order to allow fluid to flow from the channel into the chamber but not flow from the chamber into the channel.

23. The remotely actuated packing follower for a structure having a shaft extending from the structure as recited in claim 22, wherein:
said packing follower cap is built with at least two releasably connectable packing follower cap longitudinal sections with each such packing follower cap longitudinal section having at least two edges for mating with at least two other edges, such at least two other edges being on one or more of the other packing follower cap longitudinal sections, and with no packing follower cap longitudinal section being so large that such packing follower cap longitudinal section can not be removed from around the shaft extending from a structure after the packing follower longitudinal cap sections have been separated from one another;
said piston is built with at least two releasably connectable piston longitudinal sections with each such piston longitudinal section having at least two edges for mating with at least two other edges, such at least two other edges being on one or more of the other piston longitudinal sections, and with no piston longitudinal section being so large that such piston longitudinal section can not be removed from around the shaft extending from a structure after the piston longitudinal sections have been separated from one another;
said housing is built with at least two releasably connectable housing longitudinal sections with each such housing longitudinal section having at least two edges for mating with at least two other edges, such at least two other edges being on one or more of the other housing longitudinal sections, and with no housing longitudinal section being so large that such housing longitudinal section can not be removed from around the shaft extending from a structure after the housing longitudinal sections have been separated from one another; and
the packing follower cap O-ring is splittable and recombinable, the piston O-ring is splittable and recombinable, and the housing O-ring is splittable and recombinable.

24. The remotely actuated packing follower for a structure having a shaft extending from the structure as recited in claim 23, further comprising:
silicone gasket maker placed between the edges of the packing follower cap longitudinal sections which mate with one another, the edges of the piston longitudinal sections which mate with one another, and the edges of the housing longitudinal sections which mate with one another.

25. An improved male portion of an anti-leak fitting of the type having a cap and a packing follower, wherein the improvement comprises:
the cap is built with at least two releasably connectable cap longitudinal sections with each such cap longitudinal section having at least two edges for mating with at least two other edges, such at least two other edges being on one or more of the other cap longitudinal sections, and with no cap longitudinal section being so large that such cap longitudinal section can not be removed from around the shaft extending from the structure after the cap longitudinal sections have been separated from one another; and
the packing follower is built with at least two releasably connectable packing follower longitudinal sections with each such packing follower longitudinal section having at least two edges for mating with at least two other edges, such at least two other edges being on one or more of the other packing follower longitudinal sections, and with no packing follower longitudinal section being so large that such packing follower longitudinal section can not be removed from around the shaft extending from the structure after the packing follower longitudinal sections have been separated from one another.

26. The improved male portion of an anti-leak fitting as recited in claim 25, further comprising:
silicone gasket maker placed between the edges of the packing follower cap longitudinal sections which mate with one another, the edges of the piston longitudinal sections which mate with one another, and the edges of the housing longitudinal sections which mate with one another.

27. An improved anti-leak fitting of the type having a cap, a packing follower, a base, and a base extension, wherein the improvement comprises:
the cap is built with at least two releasably connectable cap longitudinal sections with each such cap longitudinal section having at least two edges for mating with at least two other edges, such at least two other edges being on one or more of the other cap longitudinal sections, and with no cap longitudinal section being so large that such cap longitudinal section can not be removed from around the shaft extending from the structure after the cap longitudinal sections have been separated from one another;
the packing follower is built with at least two releasably connectable packing follower longitudinal sections with each such packing follower longitudinal section having at least two edges for mating with at least two other edges, such at least two other edges being on one or more of the other packing follower longitudinal sections, and with no packing follower longitudinal section being so large that such packing follower longitudinal section can not be removed from around the shaft extending from the structure after the packing follower longitudinal sections have been separated from one another;
the base is built with at least two releasably connectable base longitudinal sections with each such base longitudinal section having at least two edges for mating with at least two other edges, such at least two other edges being on one or more of the other base longitudinal sections, and with no base longitudinal section being so large that such base longitudinal section can not be removed from around the shaft extending from the structure after the base longitudinal sections have been separated from one another; and
the base extension is built with at least two releasably connectable base extension longitudinal sections with each such base extension longitudinal section having at least two edges for mating with at least two other edges, such at least two other edges being on one or more of the other base extension longitudinal sections, and with no base extension longitudinal section being so large that such base extension longitudinal section can not be removed from around the shaft extending from the structure after the base extension longitudinal sections have been separated from one another.

28. The improved male portion of an anti-leak fitting as recited in claim 27, further comprising:
silicone gasket maker placed between the edges of the packing follower cap longitudinal sections which mate with one another, the edges of the piston longitudinal sections which mate with one another, and the edges of the housing longitudinal sections which mate with one another.
